(19) United States
(12) Patent Application Publication
(10) Pub. No.: US 2024/0408918 A1
(43) Pub. Date: Dec. 12, 2024

(54) THREE-DIMENSIONAL TIRE SIPE WITH VARIABLE CROSS-SECTION

(71) Applicant: BRIDGESTONE AMERICAS TIRE OPERATIONS, LLC, Nashville, TN (US)

(72) Inventors: Zachary A. Sterba, Akron, OH (US); Angu Sabariesh Anguraj, Akron, OH (US); Seth B. Gale, Kirtland, OH (US)

(73) Assignee: BRIDGESTONE AMERICAS TIRE OPERATIONS, LLC, Nashville, TN (US)

(21) Appl. No.: 18/697,633

(22) PCT Filed: Sep. 27, 2022
(86) PCT No.: PCT/US2022/077052

§ 371 Date: Apr. 1, 2024

Related U.S. Application Data
(60) Provisional application No. 63/251,443, filed on Oct. 1, 2021.

(51) Int. Cl. B60C 11/12

(52) U.S. Cl. CPC B60C 11/1218; B60C 11/1281; B60C 2011/1213

(57) ABSTRACT

Various aspects of a tire having a three-dimensional tire sipe with a variable cross-section are disclosed. In one aspect, a tire having a sipe is provided, the tire comprising: wherein the sipe is a three-dimensional sipe extending radially inwardly into the tire from a tread surface of the tire, wherein the sipe includes a horizontal undulating portion having at least one horizontal midpoint portion and at least one horizontal peak portion, wherein the sipe includes a radial undulating portion having a vertical amplitude VA1 in the at least one horizontal midpoint portion and a vertical amplitude VA2 in the at least one horizontal peak portion, and wherein the vertical amplitude VA1 is greater than the vertical amplitude VA2.

### CROSS-REFERENCE TO RELATED APPLICATIONS

This application claims priority from U.S. Provisional Patent Application No. 63/251,443 filed on Oct. 1, 2021, which is incorporated by reference herein in its entirety.

### BACKGROUND

Tires for use on vehicles may comprise a tread featuring sipes. The presence of sipes in a tire tread may create more surface edges to engage a roadway, which may increase traction in adverse road conditions. For example, a tire tread including sipes may perform better in icy, snowy, or wet road conditions than a tire tread not including sipes. Likewise, the more sipes a tire has, the better traction it may exhibit in adverse road conditions.

However, the addition of sipes to a tire tread block may reduce block stiffness, which may result in undesirable irregular wear patterns in the tire and a decrease in tire performance in dry road conditions (i.e., non-adverse conditions). Increasing the number of sipes in a tire tread block may relate to a decrease in stiffness of that tire tread block.

It may be desirable to form sipes with an interlocking shape to regain at least some of the stiffness lost in the tread block from increasing the number of sipes. It may be desirable to make the interlocking sipes as thin as possible in their interlocking region. This configuration may improve braking performance on dry surfaces. Additionally, for tires with deep tread depth, sipes must be deeper (and thus sipe blades taller) to effect the desired performance enhancements. It may therefor be desirable to make sipe blade configured to form a sipe as thin and/or as tall as possible while maintaining a durability of the sipe blade within a tire mold.

What is needed is an interlocking tire sipe configured to provide adequate block stiffness and/or braking performance, while allowing the sipe blade to be as thin and/or tall as needed while maintaining the durability of the sipe blade within a tire mold.

### SUMMARY

In one aspect, a tire having a sipe is provided, the tire comprising: wherein the sipe is a three-dimensional sipe extending radially inwardly into the tire from a tread surface of the tire, wherein the sipe includes a horizontal undulating portion having at least one horizontal midpoint portion and at least one horizontal peak portion, wherein the sipe includes a radial undulating portion having a vertical amplitude VA1 in the at least one horizontal midpoint portion and a vertical amplitude VA2 in the at least one horizontal peak portion, and wherein the vertical amplitude VA1 is greater than the vertical amplitude VA2.

In another aspect, a tire having a sipe is provided, the tire comprising: wherein the sipe is a three-dimensional sipe extending radially inwardly into the tire from a tread surface of the tire, wherein the sipe includes a horizontal undulating portion having at least one horizontal midpoint portion and at least one horizontal peak portion, wherein the sipe includes a radial undulating portion having a vertical amplitude VA1 in the at least one horizontal midpoint portion and a vertical amplitude VA2 in the at least one horizontal peak portion, wherein the vertical amplitude VA1 is greater than the vertical amplitude VA2, wherein the value of the vertical amplitude VA1 is between the value of the vertical amplitude VA2 and 1.50 mm, and wherein the value of the vertical amplitude VA2 is between 0.00 mm and the value of the vertical amplitude VA1.

### BRIEF DESCRIPTION OF THE DRAWINGS

The accompanying figures, which are incorporated in and constitute a part of the specification, illustrate various example configurations, and are used merely to illustrate various example embodiments. In the figures, like elements bear like reference numerals.

FIG. 1A illustrates a plan view of a tread 100 including a three-dimensional sipe 120 with a variable cross-section.

FIG. 1B illustrates a plan view of three-dimensional sipe 120.

FIG. 1C illustrates a sectional view of three-dimensional sipe 120 taken about section A-A illustrated in FIG. 1B.

FIG. 1D illustrates a sectional view of three-dimensional sipe 120 taken about section B-B illustrated in FIG. 1B.

FIG. 2A illustrates a sectional view of a three-dimensional sipe 220 having a vertical undulating portion 236 with 1.5 radial periods.

FIG. 2B illustrates a sectional view of three-dimensional sipe 220 having a vertical undulating portion 236 with 2.5 radial periods.

### DETAILED DESCRIPTION

Tires not intended for operation on smooth, dry surfaces typically comprise a tread pattern, including a least one groove, at least one rib, and/or a plurality of tread blocks. Tires intended for operation in inclement conditions, including for example icy or snowy conditions, may additionally comprise a plurality of sipes in the tire tread. The addition of sipes in the tire tread may result in more surface edges in the tire tread for engagement with the icy or snowy roadway.

Increasing the length of a sipe, such as providing the sipe with a three-dimensional pattern, may increase the amount and length of cutting edges available to engage snowy, icy, and/or wet road surfaces.

Providing the sipe with a three-dimensional pattern in at least one of the lateral direction of the tire and the radial direction of the tire, may allow opposing walls of the sipe to at least partially engage one another in a high friction, or locking, manner to maintain a desired stiffness of the tire tread block or tire tread rib. Maintaining a specified level of stiffness in the tire tread may mitigate or eliminate irregular wear patterns. Maintaining a specified level of stiffness in the tire tread may improve stopping distance of the tire. Maintaining a specified level of stiffness in the tire tread may improve traction of the tire.

Providing interlocking three-dimensional sipes that are as thin as possible in their interlocking regions may be advantageous. Thus, sipe thicknesses (and thus sipe blade thicknesses) of 0.3 mm or less may provide advantageous results. Further, sipe thicknesses (and thus sipe blade thicknesses) below 0.3 mm may be more advantageous.

However, sipe blades used to form sipes having the desired traction while maintaining the desired block stiffness are often made as thin as possible, which may lead to sipe blade durability issues.

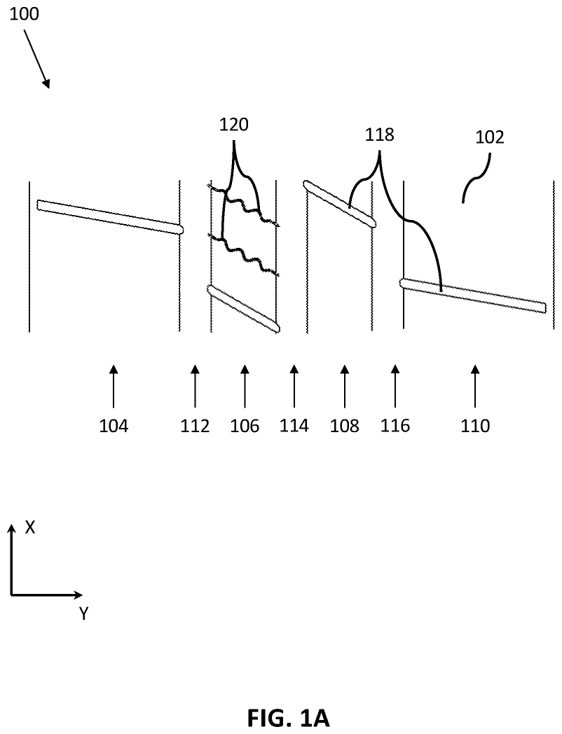

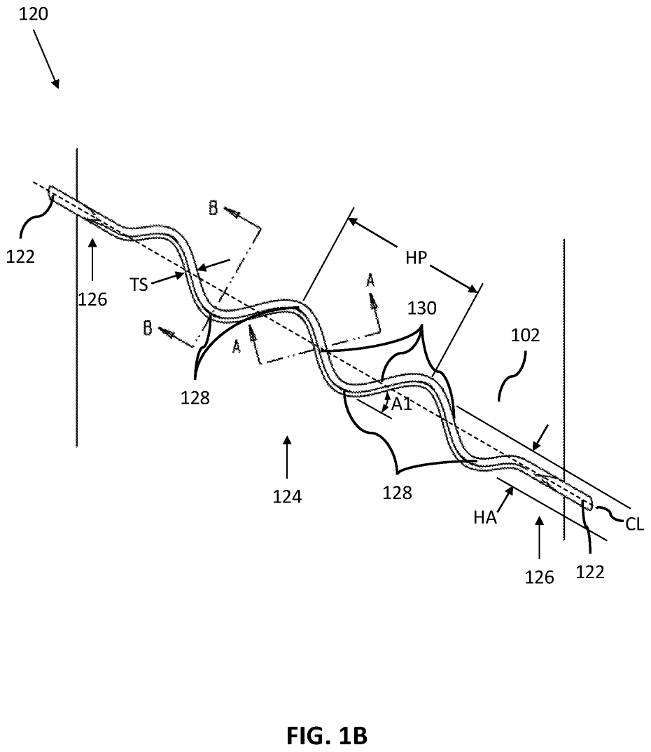

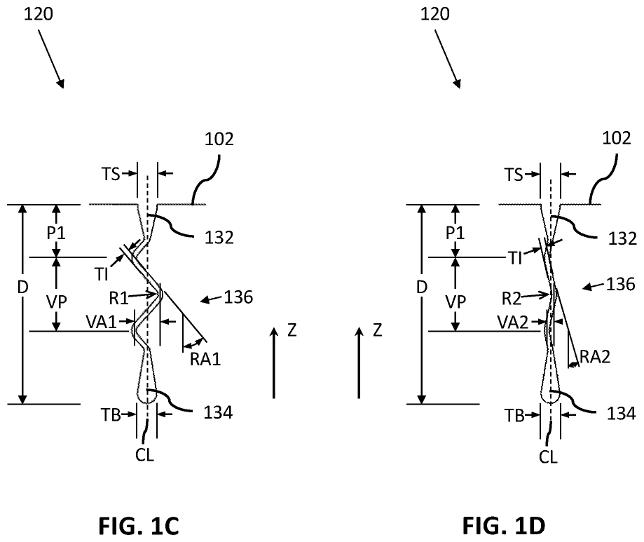

FIGS. 1A-1D illustrate a three-dimensional sipe 120 with a variable cross-section.

FIG. 1A illustrates a tire tread 100 having a tread surface 102 and at least one rib/block row 104, 106, 108, 110, separated by at least one groove 112, 114, 116. At least one rib/block row 104, 106, 108, 110 includes at least one three-dimensional sipe 120. At least one rib/block row 104, 106, 108, 110 may include at least one slot 118.

For consistency, the X-axis is oriented in the circumferential direction of the tire, the Y-axis is oriented in the axial direction of the tire, and the Z-axis is oriented in the radial direction of the tire.

FIG. 1B illustrates a plan view of three-dimensional sipe 120. Sipe 120 extends radially inwardly from tread surface 102. Sipe 120 may include terminal ends 122, which may be the axially outmost ends of sipe 120. Sipe 120 may include a horizontal undulating portion 124. Horizontal undulating portion 124 is oriented between horizontal non-undulating portions 126, which extend to terminal ends 122.

Horizontal undulating portion 124 may form, at tread surface 102, a wave, which may be a sinusoidal wave. Horizontal undulating portion 124 may instead be linear elements angled relative to one another and connected by curves/filets. Horizontal undulating portion 124 of sipe 120 includes horizontal peak portions 128 and horizontal midpoint portions 130. A sectional view of sipe 120 at horizontal midpoint portion 130 (taken about section A-A) is illustrated in FIG. 1C, while a sectional view of sipe 120 at horizontal peak portion 128 (taken about section B-B) is illustrated in FIG. 1D. These sectional views of sipe 120 include radial undulating portions 136 having differing vertical amplitudes VA1, VA2 as described further below.

Horizontal undulating portion 124 may have a surface thickness TS. Surface thickness TS may range between the value of the internal thickness TI (see FIGS. 1C and 1D) and 1.50 mm. Surface thickness TS may be between 0.05 mm and 1.50 mm. Surface thickness TS may be 0.60 mm.

At least a portion of horizontal non-undulating portions 126 may intersect groove 112, 114, 116 and wherein horizontal non-undulating portions 126 may include a sipe thickness equal to surface thickness TS, throughout the radial depth of sipe 120. Terminal ends 122 may include a sipe thickness equal to surface thickness TS, throughout the radial depth of sipe 120.

Horizontal undulating portion 124 may have a horizontal period HP. Horizontal period HP may be between 4.50 mm and 15.00 mm. Horizontal period HP may be 7.50 mm, 6.64 mm, or 10.40 mm.

Horizontal undulating portion 124 may have a horizontal amplitude HA. Horizontal amplitude HA is measured from the centerline of sipe 120 at horizontal peak portions 128. Horizontal amplitude HA may be between 1.50 mm and 3.50 mm. Horizontal amplitude HA may be 2.40 mm or 2.11 mm.

Horizontal undulating portion 124 may have a horizontal angle A1 measured between a centerline of sipe 120 (e.g., a line parallel to and extending longitudinally down the middle of horizontal non-undulating portions 126) and the centerline of a horizontal midpoint portion 130. Horizontal angle A1 may be between 35 degrees and 55 degrees. Horizontal angle A1 may be 45 degrees.

FIG. 1C illustrates sipe 120 taken about section A-A illustrated in FIG. 1B and FIG. 1D illustrates sipe 120 taken about section B-B illustrated in FIG. 1B. Sipe 120 may include a radially outer portion 132, which may include sloped walls transitioning between surface thickness TS and internal thickness TI, or parallel walls (where TS=TI). Sipe 120 may include a radially inner portion 134 that may include sloped walls transitioning between internal thickness TI and a base thickness TB, or parallel walls (where TI=TB). Sipe 120 may include radial undulating portion 136 oriented between radially outer portion 132 and radially inner portion 134. Radially inner portion 134 may have a rounded base.

Internal thickness TI may be between 0.05 mm and surface thickness TS. Internal thickness TI may be between 0.05 mm and 1.50 mm. Internal thickness TI may be 0.15 mm or 0.30 mm.

Base thickness TB may range between the value of the internal thickness TI and 1.50 mm. Base thickness TB may be between 0.05 mm and 1.50 mm. Base thickness TB may be 0.60 mm. Base thickness TB may be equal to surface thickness TS.

Radial undulating portion 136 may form a wave, which may be a sinusoidal wave. Radial undulating portion 136 may instead be linear elements angled relative to one another and connected by curves/filets.

The overall depth D of sipe 120 may be between 4.50 mm and 20.00 mm. Depth D may be 6.30 mm, 6.80 mm, 6.70 mm, or 11.18 mm.

The first radially inward peak of radial undulating portion 136 may have a depth P1 from tread surface 102 of between about 1.20 mm and 2.40 mm. Depth P1 may be 1.70 mm.

Radial undulating portion 136 may include a vertical period VP. Vertical period VP may be between 1.60 mm and 3.50 mm. Vertical period VP may be 2.30 mm or 2.50 mm.

Referring specifically to FIG. 1C and sipe 120 at a horizontal midpoint portion 130, radial undulating portion 136 may include a vertical amplitude VA1. Vertical amplitude VA1 may be between vertical amplitude VA2 and 1.50 mm. Vertical amplitude VA1 may be 0.82 mm or 1.00 mm. Vertical amplitude VA1 is greater than vertical amplitude VA2.

Sipe 120 at a horizontal midpoint portion 130, may include a radial undulating portion 136 with a radius R1. Radius R1 may be between 0.15 mm and 1.50 mm. Radius R1 may be 0.15 mm.

Radial undulating portion 136 may have a radial angle RA1 measured between a sipe 120 (e.g., a line parallel the radial, Z-axis) and the centerline of a sipe 120. Radial angle RA1 may be between radial angle RA2 and 45 degrees. Radial angle RA1 may be 41 degrees.

Referring specifically to FIG. 1D and sipe 120 at a horizontal peak portion 128, radial undulating portion 136 may include a vertical amplitude VA2. Vertical amplitude VA2 may be between vertical amplitude 0.00 mm and VA1. Vertical amplitude VA2 may be 0.23 mm or 0.70 mm. Vertical amplitude VA2 is less than vertical amplitude VA1.

Sipe 120 at a horizontal peak portion 128, may include a radial undulating portion 136 with a radius R2. Radius R2 is greater than radius R1. Radius R2 may be 0.63 mm or 4.45 mm.

Radial undulating portion 136 may have a radial angle RA2 measured between a sipe 120 (e.g., a line parallel the radial, Z-axis) and the centerline of a sipe 120. Radial angle RA2 may be between 0 degrees and angle RA1. Radial angle RA2 may be 13 degrees or 4 degrees.

Between horizontal midpoint portion 130 and horizontal peak portion 128, sipe 120 has a smooth, blended transition between the two sipe profiles illustrated in FIGS. 1C and 1D, with vertical amplitudes transitioning between vertical amplitudes VA1 and VA2, and back.

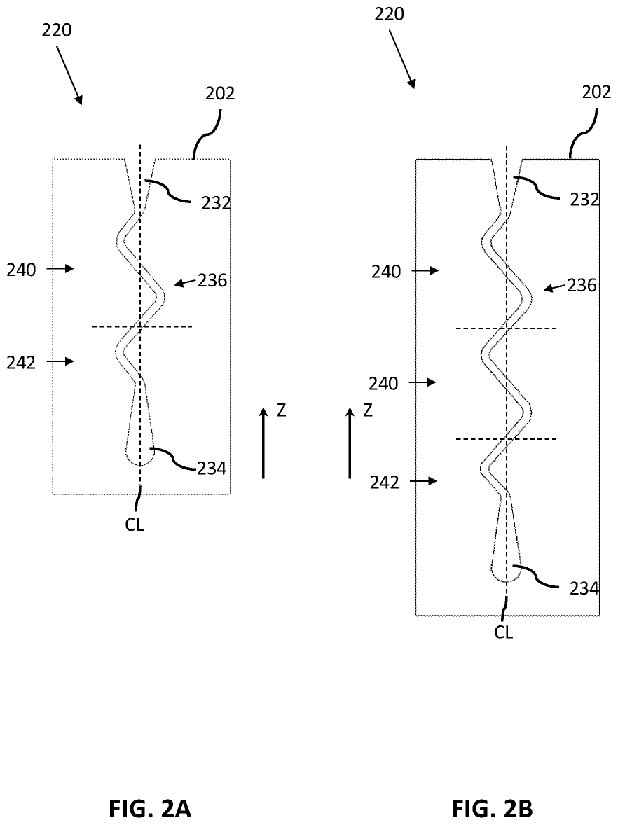

FIGS. 2A and 2B illustrate a sectional view of a three-dimensional sipe 220 having a vertical undulating portion 236 with 1.5 radial periods (FIG. 2A) and 2.5 radial periods (FIG. 2B). Sipes 220 may extend radially inwardly from a tread surface 202 and may include a radially outer portion 232, a radially inner portion 234, and a radial undulating portion 236.

Radial undulating portion 236 may include one or more full period portion 240 and/or one or more half period portion 242. Radial undulating portion 236 may include between 1.0 and 8.0 periods. Radial undulating portion 236 may include 1.5 periods, 2.5 periods, or 3.5 periods.

The varying amplitude (VA1 and VA2) as described herein may act to improve the strength of a sipe blade used to make sipes 120, 220, while allowing the thickness of the sipe blade (and sipes 120, 220) to be minimized without concerns regarding blade durability. Sipe blades used to make sipe 120, 220 may be able to be made radially “taller,” for deeper overall depths D without concerns regarding blade durability. Sipes 120, 220 may exhibit improvement in dry braking (2.5% improvement versus prior art sipes) and improvement in wet performance (2.0% improvement versus prior art sipes).

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11. Cartesian coordinates referenced herein are intended to comply with the SAE tire coordinate system.

As stated above, while the present application has been illustrated by the description of aspects thereof, and while the aspects have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A tire having a sipe, comprising:
wherein the sipe is a three-dimensional sipe extending radially inwardly into the tire from a tread surface of the tire,
wherein the sipe includes a horizontal undulating portion having at least one horizontal midpoint portion and at least one horizontal peak portion,
wherein the sipe includes a radial undulating portion having a vertical amplitude VA1 in the at least one horizontal midpoint portion and a vertical amplitude VA2 in the at least one horizontal peak portion, and
wherein the vertical amplitude VA1 is greater than the vertical amplitude VA2.

2. The tire of claim 1, wherein the value of the vertical amplitude VA1 is between the value of the vertical amplitude VA2 and 1.50 mm.

3. The tire of claim 1, wherein the value of the vertical amplitude VA2 is between 0.00 mm and the value of the vertical amplitude VA1.

4. The tire of claim 1, wherein the radial undulating portion has a thickness between 0.05 mm and 1.50 mm.

5. The tire of claim 1, wherein the sipe includes a radially outer portion that intersects the tread surface, wherein the radially outer portion has a thickness that is greater than a thickness of the radial undulating portion.

6. The tire of claim 1, wherein the sipe includes a radially inner portion, wherein the radially inner portion has a thickness that is greater than a thickness of the radial undulating portion.

7. The tire of claim 1, wherein the radial undulating portion includes a vertical period, wherein the vertical period is between 1.60 mm and 3.50 mm.

8. The tire of claim 1, wherein the radial undulating portion includes between 1.0 and 8.0 periods.

9. The tire of claim 5, wherein the sipe includes horizontal non-undulating portions oriented on each side of the horizontal undulating portion, and wherein the horizontal non-undulating portions have a thickness that is equal to the radially outer portion thickness.

10. A tire having a sipe, comprising:
wherein the sipe is a three-dimensional sipe extending radially inwardly into the tire from a tread surface of the tire,
wherein the sipe includes a horizontal undulating portion having at least one horizontal midpoint portion and at least one horizontal peak portion,
wherein the sipe includes a radial undulating portion having a vertical amplitude VA1 in the at least one horizontal midpoint portion and a vertical amplitude VA2 in the at least one horizontal peak portion,
wherein the vertical amplitude VA1 is greater than the vertical amplitude VA2,
wherein the value of the vertical amplitude VA1 is between the value of the vertical amplitude VA2 and 1.50 mm, and
wherein the value of the vertical amplitude VA2 is between 0.00 mm and the value of the vertical amplitude VA1.

11. The tire of claim 10, wherein the radial undulating portion has a thickness between 0.05 mm and 1.50 mm.

12. The tire of claim 10, wherein the sipe includes a radially outer portion that intersects the tread surface, wherein the radially outer portion has a thickness that is greater than a thickness of the radial undulating portion.

13. The tire of claim 10, wherein the sipe includes a radially inner portion, wherein the radially inner portion has a thickness that is greater than a thickness of the radial undulating portion.

14. The tire of claim 10, wherein the radial undulating portion includes a vertical period, wherein the vertical period is between 1.60 mm and 3.50 mm.

15. The tire of claim 10, wherein the radial undulating portion includes between 1.0 and 8.0 periods.

16. The tire of claim 12, wherein the sipe includes horizontal non-undulating portions oriented on each side of the horizontal undulating portion, and wherein the horizontal non-undulating portions have a thickness that is equal to the radially outer portion thickness.
